(19) United States
(12) Patent Application Publication
(10) Pub. No.: US 2007/0100705 A1
(43) Pub. Date: May 3, 2007

(54) Virtual reality shopping system

(75) Inventor: Wei-Ching Chen, Taipei (TW)

Correspondence Address: TROXELL LAW OFFICE PLLC, SUITE 1404, 5205 LEESBURG PIKE, FALLS CHURCH, VA, 22041, US

(73) Assignee: Royal Planet Co., Ltd.

(21) Appl. No.: 11/263,929

(22) Filed: Nov. 2, 2005

(51) Int. Cl. G06Q 30/00

(52) U.S. Cl. 705/26

(57) ABSTRACT

A virtual reality shopping system is composed of a login page, a character configuration and selection page, and a virtual reality shopping page. The login page is configured as a system for acknowledging or adding members. After a basic buyer character is chosen, the character configuration and selection page can provide a buyer for performing a modeling to the virtual character. The virtual reality shopping page is designed as a virtual reality three-dimensional shopping website enabling individual buyers to mutually interact by assembling virtual map files, according to the design of virtual reality map files and the interaction with a plurality of virtual characters in the map files. In addition, the virtual characters can fit on virtual clothes or accessories in advance, when performing an Internet transaction on the virtual reality shopping website.

### BACKGROUND OF THE INVENTION

(a) Field of the Invention

The present invention relates to a virtual reality shopping system, and more particularly to a virtual reality shopping system which manifests a shopping website in a fashion of game software in analogy to a virtual reality, and is provided with an agile, convenient, interactive, and comprehensive shopping function. By a virtual reality design of a map file whose view can be zoomed in and out, and an interaction of a plurality of virtual characters in the map file, the present invention can be used to replace existing dull and simple shopping websites without an interaction function, and can enable individual buyers to mutually interact by assembling the virtual map files. In addition, when a virtual character is performing an internet transaction on the virtual reality shopping website, virtual clothes, accessories, and decorations can be first fitted on the virtual character with a 95% of similarity to the real character for demonstration, and the shopping player can discuss with other players or virtual salesclerks before deciding whether to perform the internet shopping. On the other hand, the virtual characters can change their hairstyles and a background system to be matched with, depending on requirement.

(b) Description of the Prior Art

The rapid development of technology effectively provides a living standard to people and shortens a distance between them. By the invention and application of Internet, a concept of “a bosom friend afar brings a distant land near” is realized. During the development of Internet, the Internet shopping has replaced the conventional consuming pattern and become an important trend of development.

However, on a conventional shopping webpage, only a simple introduction in texts along with a few pictures are provided for goods, which inevitably cause several drawbacks in basic structure as follows:

(1) There is a lack of protection to a consumer during shopping; only a few two-dimensional pictures along with a simple introduction in texts cannot provide enough information of shopping to the consumer, which will easily enable the consumer to buy dissatisfactory goods.

(2) The shopping environment is simple and not friendly; there is no fun of interaction with salesclerks or other buyers during shopping, when the consumer is browsing the webpages by oneself, and it is naturally lacking a sense of feeling of the versatility of goods during shopping in a department store, if the consumer is watching a simple background of Internet.

(3) Whether the goods can be matched with the consumers themselves cannot be certain through the internet shopping, and there is no chance for the consumers to match the goods such as clothes, pants, or hats in reality. In addition, it is also not able to ascertain the sizes of goods to be purchased.

Accordingly, how to resolve the inferior configuration of this kind of conventional shopping webpage constituted by a simple introduction of texts along with a few pictures, which is in short of a mutual trust mechanism, inhibits a development of internet shopping market, and is provided with troubles of inconvenience and difficulty in implementation caused by a clumsy application, is a technical issue to be solved.

### SUMMARY OF THE INVENTION

According to the shortcomings of the conventional technique described before, the present invention is to provide a virtual reality shopping system for solving the shortcomings of the conventional technique. This virtual reality shopping system can effectively avoid the shortcomings of the conventional shopping webpage described before, can be used conveniently, can effectively reduce the shortcomings of multiple transaction problems, simplicity, and dullness with a simple introduction in texts along with several pictures, can enable a fitting on in virtual reality, and can even simulate a virtual character wearing a decoration in all kinds of circumstances according to a change in background. It is very flexible in controlling the system, and a fun of interaction and a sense of feeling can be achieved through interacting with a plurality of virtual characters in an interface set up by the virtual reality shopping website having a scaleable and changeable background, thereby providing the virtual reality shopping system with an interactivity, a convenience, a real implementation, a variable matching function, and a strong practicability.

To achieve the aforementioned and other objects, the present invention is to provide a virtual reality shopping system which can be applied to webpages of an internet shopping system, and refers in particularly to a kind of manifestation of shopping website in a fashion of game software analogous to a virtual reality, without simply facing a description in texts and a scarce of pictures. In the present invention, the goods can be fitted on, and the background can be changed to match a dressing to be worn at a suitable place. In addition, a buyer can even interact with other shopping players and virtual salesclerks. The shopping system comprises at least a login page which is configured as a computer system for acknowledging or adding members; the login page is provided with an account and password for confirming the identity of member. After connecting to the Internet, the system transfers to a character configuration and selection page to perform an Internet transaction with a virtual reality shopping page described below. Protective functions such as a firewall or privacy can be provided. The character configuration and selection page is provided with a plurality of optional basic buyer characters. In addition to providing buyer's basic choices and a querying function, the system can perform a modeling to a virtual character based on the information input to each character by the buyer, such as the height, the weight, the figures, the picture of head, and the hair style, after a basic buyer character is chosen. The similarity of the modeled virtual character to the real character can achieve 95%. The virtual reality shopping page is designed to be a virtual reality three-dimensional shopping website whose map files are provided with scaleable views and can perform an Internet transaction after matching with the modeled virtual characters. The virtual characters can also show their expressions in the virtual reality shopping website, and can dialog with the virtual salesclerks or other shopping players.

Other than having the account and password for confirming members to transfer to the character configuration and selection page, the login page is also provided with an auxiliary conversion page, such as a conversion page for adding new members, and a conversion page for changing members' information.

Moreover, by the design of map files, and the interactivity of plurality of virtual characters in the map files, the present invention can be used to replace existing dull and simple shopping websites without an interaction function, and can enable individual buyers to mutually interact by assembling the virtual map files. In addition, when a virtual character is performing an internet transaction on the virtual reality shopping website, virtual clothes, accessories, and decorations can be first matched on the virtual character with a 95% of similarity to the real character for demonstration, and the shopping player can discuss with other players or virtual salesclerks before deciding whether to perform the internet shopping. On the other hand, the virtual characters can even change different backgrounds in the virtual map files in advance, in order to match with a place to attend, depending on the attending place where the purchased clothes should be worn, and then fit on the purchased clothes to decide whether the clothes will match with the attending place.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a flow diagram for logging into a webpage of the present invention.

FIG. 2 shows a flow diagram of an authentication and transaction of the present invention.

### DETAILED DESCRIPTION OF THE PREFERRED EMBODIMENTS

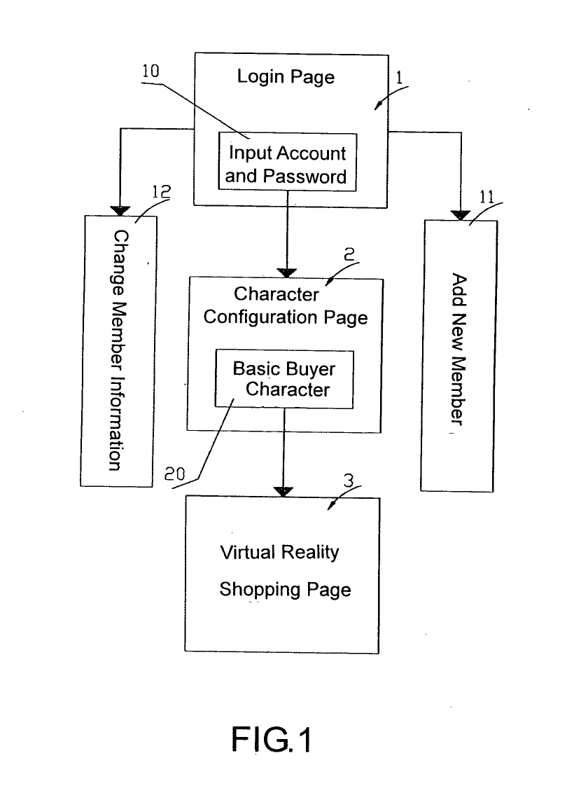

Referring to FIG. 1, the present invention is to provide a virtual reality shopping system including a login page 1 which is configured as a computer system for acknowledging or adding members that an account and password 10 are input for confirming the identity of member, followed by connecting to the internet and transferring to a character configuration and selection page 2; and an auxiliary conversion page such as a conversion page 11 having a function of adding new members or a conversion page 12 for changing members' information. The login page 1 also provides a protective function such as a firewall or privacy. The character configuration and selection page 2 is provided with a plurality of optional basic buyer characters 20, and one option can be chosen among “creating a basic buyer character,” “querying related conditions of a basic buyer character,” and “entering the shopping system with the basic character,” upon selecting the basic buyer character 20. If “creating a basic buyer character” is chosen, the system will enter into a virtual character modeling page 21, and can model the virtual character to a 95% of similarity to the real character, according to the information input to each character, such as the height, the weight, the figures, the picture of head, and the hair style. On the other hand, if “entering the shopping system with the basic character” is chosen, the system will enter into a virtual reality shopping page 3.

The virtual reality shopping page is an intermediate system whose background pages are designed as a virtual reality three-dimensional shopping website. Map files of the virtual reality three-dimensional shopping website are provided with scaleable views, and are able to perform an internet transaction along with the modeled virtual characters. The virtual characters can also show their expressions in the virtual reality shopping website, and can dialog with virtual salesclerks or other shopping players.

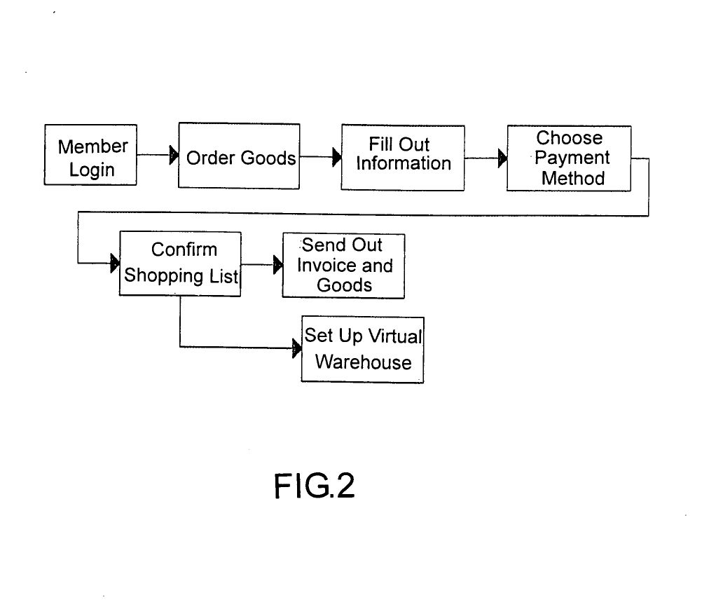

Referring to FIG. 2, new members can be added in through the conversion page having the function of adding new members. The intermediate system of the virtual reality map files after adding the members, and the design of interacting with a plurality of virtual characters in the map files can be used to replace existing dull and simple shopping websites without an interaction function, and can enable individual buyers to mutually interact by assembling the virtual map files. In addition, when a virtual character is performing an internet transaction on the virtual reality shopping website, a virtual clothes, accessory, and decoration can be first matched on the virtual character with a 95% of similarity to the real character for demonstration, and the shopping player can discuss with other players or virtual salesclerks before deciding whether to perform the internet shopping. On the other hand, the virtual characters can even change different backgrounds in the virtual map files in advance, in order to match with a place to attend, depending on the attending place where the purchased clothes should be worn, and then fit on the purchased clothes to decide whether the clothes will match with the attending place. Once the buyer has decided to order the goods, and has written out related information and chosen a payment method, the shopping system will confirm the shopping list and then send out the invoice and the shopping list. Meanwhile, virtual goods with same amount of price will be emplaced into a warehouse of the basic buyer character 20, in order to facilitate the buyer to continue selecting the goods that can be mutually matched with.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A virtual reality shopping system including a login page which is configured as a computer system for acknowledging or adding members and enables an account and password to be input for confirming the identity of member followed by connecting to the internet and transferring to a character configuration and selection page, and which is able to provide a protective function such as a firewall and privacy; an auxiliary conversion page; a character configuration and selection page which is provided with a plurality of optional basic buyer characters and can be transferred to a virtual reality shopping page upon selecting the basic buyer character; a virtual reality shopping page which is an intermediate system whose background pages are designed as a virtual reality three-dimensional shopping website whose map files are provided with scaleable views and a function of changing the background, and which can perform an internet transaction after matching with modeled virtual characters who can also show their expressions in the virtual reality shopping website and can dialog with virtual salesclerks or other shopping players.

2. The virtual reality shopping system according to claim 1, wherein the auxiliary conversion page can be a conversion page for adding new members, or a conversion page for changing members' information.

3. The virtual reality shopping system according to claim 1, wherein when selecting a basic buyer character, a buyer can choose to enter into a virtual character modeling page for performing a modeling to the virtual character according to information input to each character, such as the height, the weight, the figures, the picture of head, and the hair style, so as to model a virtual character which is extremely similar to a real character.
